(19) United States
(12) Patent Application Publication
(10) Pub. No.: US 2025/0341136 A1
(43) Pub. Date: Nov. 6, 2025

(54) IMPROVED WELL COMPONENT

(71) Applicant: WEAR DETECTION TECHNOLOGIES PTY LTD, Canning Vale (AU)

(72) Inventors: Michael Heitzmann, Sandgate (AU); Ayrton Sue, Karrinyup (AU); Daniel Berti, Duncraig (AU); Reece Kibble, Bibra Lake (AU); Minh Sang Duong, Morely (AU); Aaron Leech, Tamborine (AU)

(21) Appl. No.: 18/785,821

(22) PCT Filed: Jan. 27, 2023
(86) PCT No.: PCT/AU2023/050047

§ 371 Date: Jul. 26, 2024

(30) Foreign Application Priority Data
Jan. 27, 2022 (AU) 2022900143

(51) Int. Cl. E21B 17/10

(52) U.S. Cl. CPC E21B 17/1071

(57) ABSTRACT

A well component for use in a well production tubing, the well component comprising:
(a) a wearable material; and
(b) a fluorophore.

### CROSS-REFERENCE TO RELATED APPLICATION

This application claims priority through International Application No. PCT/AU2023/050047, filed Jan. 27, 2023, to Australian patent application 2022900143, filed Jan. 27, 2022, the entirety of which is incorporated by reference.

### FIELD OF THE INVENTION

This invention relates generally to well production technology and more particularly concerns well components, subject to wear, such as rod guides used in well production tubing. The present invention also relates to a method of detecting wear of a well component in a well.

### BACKGROUND OF THE INVENTION

Oil and gas wells use subsurface equipment for the extraction of the well fluid. In general, the downhole components either reciprocate or rotate to pump the well fluid to the surface. The key parts of the well are the well production tubing through which the well fluid from the well passes, the rod driving the action to pump the well fluid, and guides for separating the rod from the well production tubing and/or to enhance flow of the well fluid.

The rods, with attached guides, are assembled into a string that is then located in the well production tubing. During operation, contact between the components and/or with the well fluid results in wear. Excessive wear of the components can lead to component failure and/or render a well non-functional or to operate at sub-optimal levels. Therefore, components of the string, such as the guides, need to be changed out to continue efficient operation.

Decisions on when to change out a component can have an important impact on the efficient operation of a well and accurate data on component wear is therefore valuable as it informs and improves any such decisions.

The present invention seeks to provide a well component, a receptacle for use with the well component and a method that addresses or at least partially ameliorate the problems with existing well components, subject to wear. At the very least, the present invention seeks to provide a useful alternative to currently available solutions for detecting wear in well components.

### SUMMARY OF THE INVENTION

The present invention provides a well component for use in a well production tubing, the well component comprising:
(a) a wearable material; and
(b) a fluorophore.

The present invention also provides an assembly for use in a well production tubing, the assembly comprising a well component according to the present invention.

The present invention also provides a method of detecting wear of a well component in a well, the method comprising the steps of:
(a) incorporating a well component in the well, wherein the well component comprises a wearable material and a fluorophore; and
(b) assaying a well fluid for the fluorophore;
wherein the presence of the fluorophore in the well fluid is indicative of the wear.

The present invention also provides a receptacle that is adapted to be received in a retaining means in a well component, the receptacle comprising:
(a) a frangible capsule including a detectable material; and
(b) a housing for the frangible capsule, wherein the housing comprises a wearable material.

The present invention provides a well component for receiving a receptacle, the well component comprising:
(a) a body formed from a wearable material; and
(b) at least one retaining means for the receptacle, wherein the retaining means is located in the body.

### BRIEF DESCRIPTION OF THE DRAWINGS

FIG. 1 is perspective view of a well component according to a preferred embodiment of the first aspect of the invention;

FIG. 2 is a perspective, exploded view of a receptacle according to a first embodiment of the fourth aspect of the invention showing the two main parts thereof;

FIG. 3a is a perspective view of the receptacle in FIG. 2, shown assembled;

FIG. 3b is a side view of the receptacle in FIG. 2, shown assembled;

FIG. 3c is an end view of the receptacle in FIG. 2, shown assembled;

FIG. 3d is cross-sectional view H-H in FIG. 3c;

FIG. 4a is an isometric view of a well component according to a first embodiment of the fifth aspect of the present invention in the form of a rod guide;

FIG. 4b is a top view of the well component of FIG. 4a;

FIG. 4c is an exploded perspective view of the well component of FIG. 4a, showing its parts;

FIG. 4d is another top view of the well component of FIG. 4a;

FIG. 4e is FIG. 4d clipped along line J-J in FIG. 4d;

FIG. 4f is cross-sectional view J-J in FIG. 4d rotated anti-clockwise 127.5°;

FIG. 4g is Detail A in FIG. 4f magnified 5×;

FIG. 5a is an isometric view of a well component according to a second embodiment of the fifth aspect of the present invention in the form of a rod guide;

FIG. 5b is a top view of the well component of FIG. 5a;

FIG. 5c is another top view of the well component of FIG. 5a;

FIG. 5d is FIG. 5c clipped along line A-A in FIG. 5c;

FIG. 5e is cross-sectional view A-A in FIG. 5c rotated anti-clockwise 127.5°;

FIG. 5f is Detail B in FIG. 5e magnified 5×;

FIG. 6a is an isometric view of a well component according to a third embodiment of the fifth aspect of the present invention in the form of a rod guide;

FIG. 6b is an exploded view of FIG. 6a showing its components;

FIG. 6c is a side view of the well component of FIG. 6a;

FIG. 6d is cross-sectional view D-D in FIG. 6c; and

FIG. 6e is FIG. 6d magnified 2×;

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

A well component for use in a well production tubing, the well component comprising:
(a) a wearable material; and
(b) a fluorophore.

Applicant has surprisingly found that a fluorophore included in a well component is useful for monitoring the wear of that well component and helping ensure that the well component is replaced or some other intervention is undertaken prior to it wearing to a point that has deleterious consequences.

The well component may be a rod guide such as a sucker rod guide, a well liner or tube, a rod such as a sucker rod and a fitting or coupling for any of the aforementioned well components.

The wearable material may be a separate component that is adapted to be mechanically fitted to the well component.

The wearable material may be adapted to form an integral part of the well component.

The wearable material may be adapted to be moulded onto the well component.

The wearable material may be a material selected from a list of materials consisting of: a polymer, a thermoplastic polymer such as thermoplastic polyurethane or polyethylene terephthalate, a polyamide, polyamide 6, polyamide 6-6, polyamide 11, polyamide 12, aliphatic polyketone, polyethylene, polyacetal such as polyoxymethylene, thermoplastic fluoropolymer such as polyvinylidene difluoride and PTFE.

The wearable material may be a reinforced polymer.

The wearable material may comprise a lubricant and/or a toughener.

The fluorophore may comprise an excitation wavelength of 325-425, 345-400, 350-390, 360-380, 365-375, 365, 366, 367, 368, 369, 370, 371, 372, 373 or 374 nm.

The fluorophore may be a dye.

Preferably, the fluorophore is 1,3,6,8-pyrene tetrasulfonic acid tetrasodium salt (PTSA). The fluorophore may also be rhodamine, fluorescein, eosin or dansyl.

Preferably, the fluorophore is a solid such as a powder or a fluid such as a liquid.

The fluorophore may be integrated into the wearable material.

The fluorophore may be adapted to persist in well fluid.

Preferably, the fluorophore is adapted to be detected in the well fluid.

Preferably, the fluorophore is adapted to be detected in the well fluid at a location above ground.

Preferably, the fluorophore is located at a predetermined depth in the wearable material.

Preferably, the predetermined depth is about 5-15, 6-13, 7-12 or 7-8 mm below the outer surface of the wearable material.

When the well component is a rod guide with a generally circular cross section, the fluorophore may be located at a predetermined position relative to a point at the centre of the circular cross section. For example, the predetermined position may be about 10-30, 15-25, 17-23, or 21 mm from the centre of the circular cross section.

When the well component is a rod guide, the fluorophore may be located within a fluid flow enhancer on the surface of the rod guide, such as a vane.

When the well component is a rod guide it may comprise a first body affixed, mounted or moulded directly on a rod.

Alternatively, the rod guide may comprise a first body affixed, mounted or moulded directly on a rod and second body affixed, mounted, or moulded to the first body.

When the rod guide comprises a first body and second body, the first and second body may be formed of material with different wear characteristics.

When the rod guide comprises a first body and second body, the first and second body may be formed so as to be keyed or interlocked together to prevent or limit relative rotation or movement between the first and second body when the rod guide is in use.

The fluorophore may be located in a retaining means in the wearable material.

Preferably, the retaining means is adapted to release the fluorophore when a part of said retaining means is breached. In this regard, once the retain means is breached, the fluorophore mixes with and forms part of the surrounding well fluid.

The retaining means may comprise a cavity or void in the wearable material.

The retaining means may further comprise a receptacle that defines or is adapted to be received therein.

Preferably, the receptacle is formed from a material that is less wear resistant than the wearable material.

The receptacle may comprise a removable cap and a body.

Preferably, the well component comprises a plurality of retaining means.

Preferably, the well fluid comprises a turbidity of at least 1000 NTU, 2000 NTU, 3000 NTU, 4000 NTU, 5000 NTU, 7500 NTU, 10000 NTU, 12500 NTU, 15000 NTU, 17500 NTU, 20000 NTU, 22500 NTU, 25000 NTU, 27500 NTU, 30000 NTU.

The well fluid may comprise a slurry.

The well fluid may comprise a particulate material.

The particulate material may be rock or sand.

The well fluid may comprise oil and/or gas.

According to a second aspect the present invention provides an assembly for use in a well production tubing, the assembly comprising a well component according to a first aspect of the present invention.

Preferably, the assembly comprises a plurality of the well components.

One or more of the aspects of the invention described above can be used in a method to detect wear in a well component. Thus, according to a third aspect of the invention, the present invention provides a method of detecting wear of a well component in a well, the method comprising the steps of:
(a) incorporating a well component in the well, wherein the well component comprises a wearable material and a fluorophore; and
(b) assaying a well fluid for the fluorophore;
wherein the presence of the fluorophore in the well fluid is indicative of the wear.

The step of assaying the well fluid for the fluorophore may comprise the use of an optical sensor arrangement.

Preferably, the optical sensor arrangement comprises a light source such as an LED and a light detector such as a photodiode.

The physical characteristics of the well fluid may impact on the detection of the fluorophore. Thus, the method of detecting wear may further comprise the step of:
(c) measuring a physical characteristic of the well fluid.

Preferably, the measuring comprises quantifying the physical characteristic.

Preferably, the physical characteristic is turbidity.

Preferably, the measure of the physical characteristic is used to inform the step of assaying the fluorophore. For example, the measure of the physical characteristic may be used to process a signal based on the detection of the fluorophore. Even more preferably, the measure of the physical characteristic may be used to amplify the signal relative to the noise in the signal.

According to a fourth aspect, the present invention provides a receptacle that is adapted to be received in a retaining means in a well component, the receptacle comprising:
(a) frangible capsule including a detectable material; and
(b) a housing for the frangible capsule, wherein the housing comprises a wearable material.

Preferably, the frangible capsule is formed from glass. Alternatively, the frangible capsule is formed from a material selected from the list consisting of: acrylic and ceramic.

Preferably, the frangible capsule has a generally circular cross sectional shape.

Preferably, the frangible capsule is generally cylindrical in shape.

Preferably, the frangible capsule is tubular.

Preferably, the frangible capsule comprises at least one end comprising a seal.

Preferably, the seal comprises a plug.

Preferably, the plug is formed from a resin such as an epoxy resin.

Preferably, the detectable material is a fluorophore such as a fluorescent material selected from the list consisting of fluorescein, rhodamine, lissamine, coumarin, perylene and chlorophyllin. The detectable material may also comprise a material selected from the list consisting of: a radioactive material or chemical. The detectable material may also be acetylene.

Preferably, the detectable material comprises a solid, such as a powder.

The detectable material may also comprise a fluid such as a liquid.

Preferably, the housing is adapted to releasably receive the frangible capsule.

Preferably, the housing is adapted to slidingly receive the frangible capsule.

Preferably, the housing is adapted to receive the frangible capsule via a friction fit.

Preferably, the frangible capsule is retained within the housing via an adhesive.

Preferably, the housing comprises a chamber that is shaped and sized to receive the frangible capsule.

Preferably, the chamber comprises a first part for receiving the frangible capsule and a second part that defines an expansion space or void for expediting the release of the detectable material when the frangible capsule is breached.

Preferably, the expansion space or void extends parallel to a main longitudinal axis of the first part of the chamber and towards an outer surface of the housing.

Preferably, the housing is sized and shaped to friction fit in the retaining means.

Preferably, the housing is held in the retaining means via an adhesive.

Preferably, the wearable material comprises one or more of the following properties: optimised abrasion resistance, resistance to fatigue, low water absorption, resistance to chemicals, high impact strength, high strength, high rigidity and good dimensional stability.

A preferred wearable material comprises a synthetic polymeric material. Preferably, the polymeric material is a polyamide material. Preferably, the polymeric material comprises glass fibre, such as 20-40% or about 30% glass fibre. In one particular form the polyamide material is nylon such as nylon N6 (PA6).

According to a fifth aspect, the present invention provides a well component for receiving a receptacle according to a fourth aspect of the present invention, the well component comprising:
(a) a body formed from a wearable material; and
(b) at least one retaining means for the receptacle, wherein the retaining means is located in the body.

As described above, the well component may be a rod guide such as a sucker rod guide, a well liner or tube, a rod such as a sucker rod and a fitting or coupling for any of the aforementioned well components.

Preferably, the retaining means is a void or cavity.

Preferably, the retaining means is located on an outer surface of the body.

Preferably, the well component is a sucker rod guide comprising at least one fluid flow enhancer, such as a vane, on its outer surface that assists the transfer of fluid out of a well. When the well component comprises a vane, the retaining means may be located in the vane.

Preferably, the retaining means is located in a first part of the vane that defines spiral shaped path around and along an outer longitudinal surface of the body of the sucker rod guide.

Preferably, the vane comprises a second part that defines a straight path along the outer longitudinal surface of the body of the sucker rod guide. When the vane comprises the second part, the retaining means may be located in the second part. In this regard, locating the retaining means and/or the receptacle in the second part, that defines a straight path may have advantages, at least from a manufacturing efficiency perspective, relative to locating the receptacle in the first part of the vane.

When there is a plurality of retaining means and/or receptacles they may be located in the first part and/or the second part of the vane.

When there are two or more vanes it is preferred for there to be at least one retaining means for the receptacle in each vane. Preferably, there are two retaining means in each vane.

Preferably, the well component further comprises the receptacle.

The fourth and fifth aspects of the invention can be used to detect wear of a well component. Thus, the present invention also provides, according to a sixth aspect, a method of detecting wear of a well component in a well, the method comprising the steps of:
(a) providing a well component formed from a wearable material and including a receptacle that includes:
   (i) a frangible capsule including a detectable material; and
   (ii) a housing for the frangible capsule, wherein the housing comprises a wearable material; and
(b) assaying a well fluid for the detectable material;
wherein the presence of the detectable material in the well fluid is indicative of the wear.

Preferably, the well component comprises a plurality of receptacles.

Preferably, the detectable material is a fluorophore.

Preferably, the step of assaying the well fluid comprises the use of an optical sensor arrangement.

Preferably, the optical sensor arrangement comprises a light source such as an LED and a light detector such as a photodiode.

### Advantages

Whilst not limited to the following applicant believes the present invention has a number of advantages including one or more of the following:
(i) the fluorophore can be reliably detected in highly turbid well fluids;
(ii) fluorophore detection provides wear information on downhole well components, which may be used to provide advance warning before damage is caused. Maintenance can be scheduled in advance, minimising well down-time and costs; and
(iii) the fluorophore can be detected using non-intrusive optical methods;

Furthermore, the receptacle described herein provides a convenient and reliable way to incorporate a detectable material such as a fluorophore in a well component to enable the wear of the well component to be accurately assessed and monitored.

### General

Those skilled in the art will appreciate that the invention described herein is susceptible to variations and modifications other than those specifically described. The invention includes all such variation and modifications. The invention also includes all of the steps and features referred to or indicated in the specification, individually or collectively and any and all combinations or any two or more of the steps or features.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness. None of the cited material or the information contained in that material should, however be understood to be common general knowledge.

The present invention is not to be limited in scope by any of the specific embodiments described herein. These embodiments are intended for the purpose of exemplification only. Functionally equivalent products and methods are clearly within the scope of the invention as described herein.

The invention described herein may include one or more range of values (e.g., size etc). A range of values will be understood to include all values within the range, including the values defining the range, and values adjacent to the range which lead to the same or substantially the same outcome as the values immediately adjacent to that value which defines the boundary to the range.

Throughout this specification, unless the context requires otherwise, the word “comprise” or variations such as “comprises” or “comprising”, will be understood to imply the inclusion of a stated integer or group of integers but not the exclusion of any other integer or group of integers.

Other definitions for selected terms used herein may be found within the detailed description of the invention and apply throughout. Unless otherwise defined, all technical terms used herein have the same meaning as commonly understood to one of ordinary skill in the art to which the invention belongs.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. In the various Figures the same reference numerals have been used to identify similar elements.

### DETAILED DESCRIPTION OF THE PREFERRED EMBODIMENTS

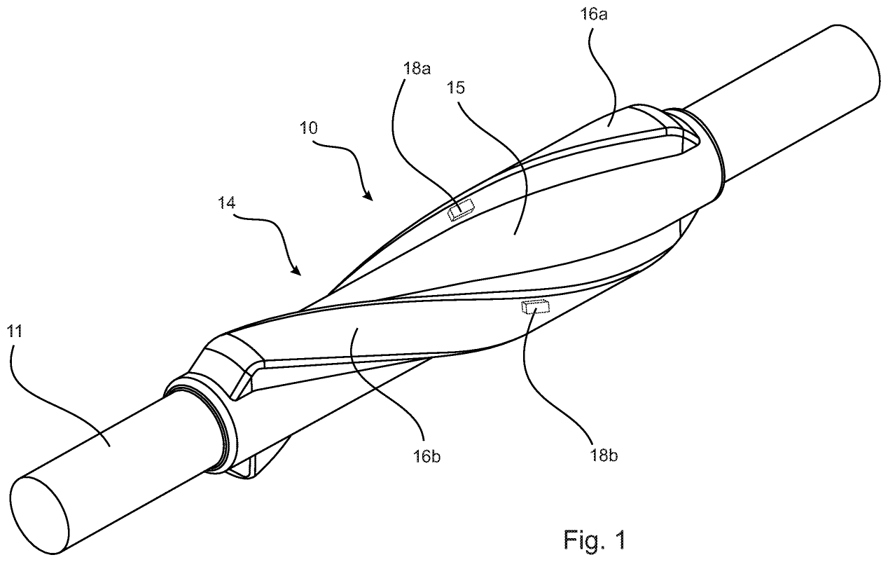

A well component for use in a well production tubing according to one embodiment of the first aspect of the present invention in the form of a rod guide is depicted in FIG. 1 and generally indicated by the numeral 10. The rod guide 10 is fitted to a well component in the form of a sucker rod 11 and is formed from a wearable material in the form of a thermoplastic polyurethane.

The rod guide 10 has a generally cylindrical main body 15 and projecting from the outer surface of the main body 15 is a fluid flow enhancer in the form of a pair of vanes 16a, 16b that extend lengthwise along the outer surface of the main body 15 of the guide 10. Vanes 16a, 16b are spaced equidistantly and define a spiral shaped path for a fluid, such as oil or gas, between the guide 10 and the well production tubing (not shown).

Each of vanes 16a, 16b includes a fluorophore, in the form of PTSA, located in a retaining means in the wearable material in the form of cavities 18a, 18b that are located below the surface of wearable material when the guide is manufactured. When the wearable material wears to the point that a cavity 18a or 18b is breached, the PTSA is released into the surrounding well fluid and can be detected using an appropriate assay or detection system located above ground.

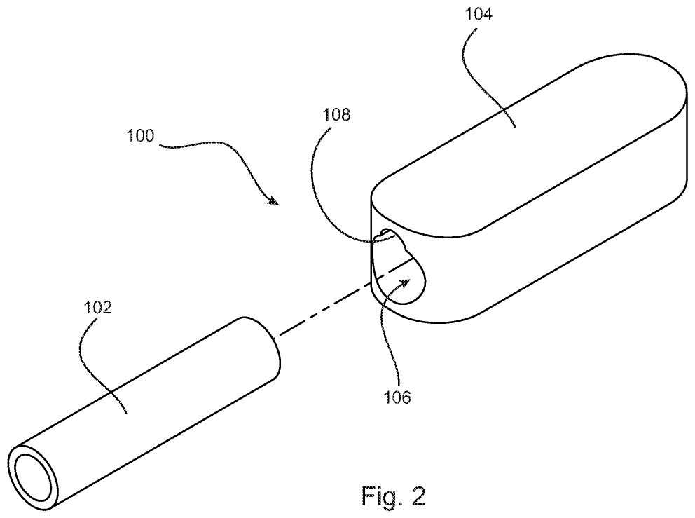

A receptacle according to a preferred embodiment of the fourth aspect of the present invention is depicted in FIG. 2 and generally indicated by the numeral 100. The receptacle 100 includes a frangible capsule in the form of a glass tube 102 containing detectable material in the form of PTSA in powder form (no shown) and a housing 104 formed of a wearable material for the glass vial 102. The wearable material forming the housing 104 is nylon N6 (PA6) and is less resistant to wear than the well component into which it is mounted.

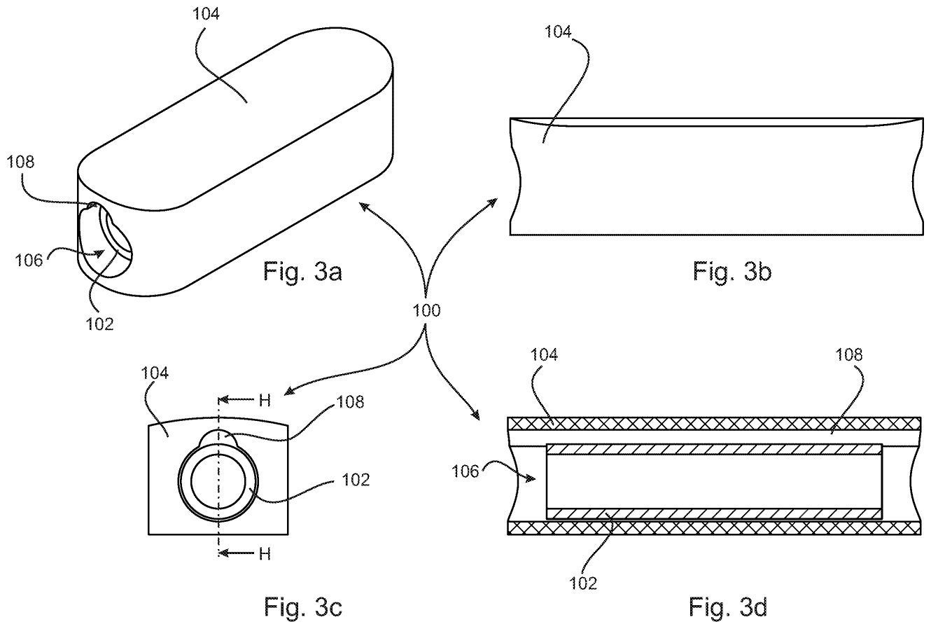

The receptacle 100 from FIG. 2 is also depicted in FIGS. 3a to 3d that show the receptacle assembled with the glass tube 102 located in the housing 104. The housing 104 includes a chamber with a first part 106 that is shaped and sized to slidingly receive the glass tube 102 and retain it via a friction fit and/or an adhesive and a second part that defines an expansion void 108 that expedites the release of the PTSA when the glass vial 102 is breached. The expansion void 108 extends parallel to the main longitudinal axis of the first part 106 of the chamber and towards the outer surface of the housing 104.

During manufacture, the PTSA powder is inserted into the glass tube 102 and the ends of the glass tube 102 are sealed with plugs (not shown) formed from an epoxy resin before or after the glass tube 102 is inserted into the housing 104.

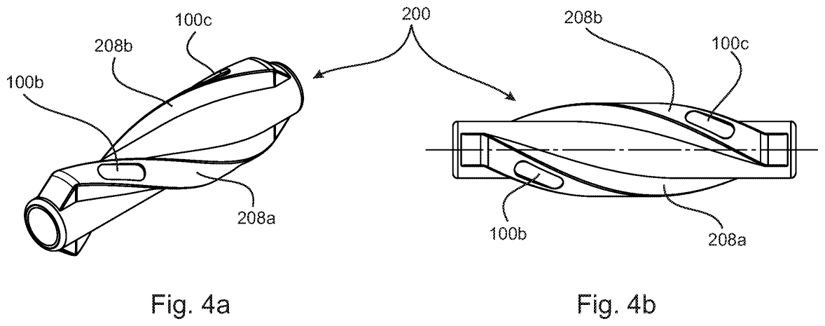

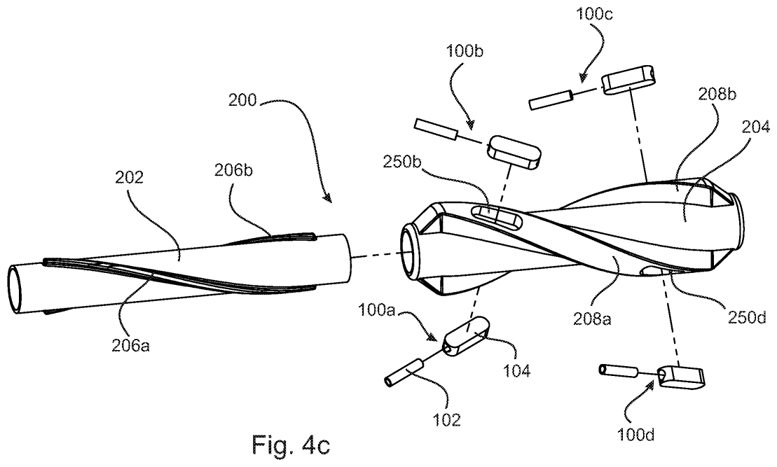

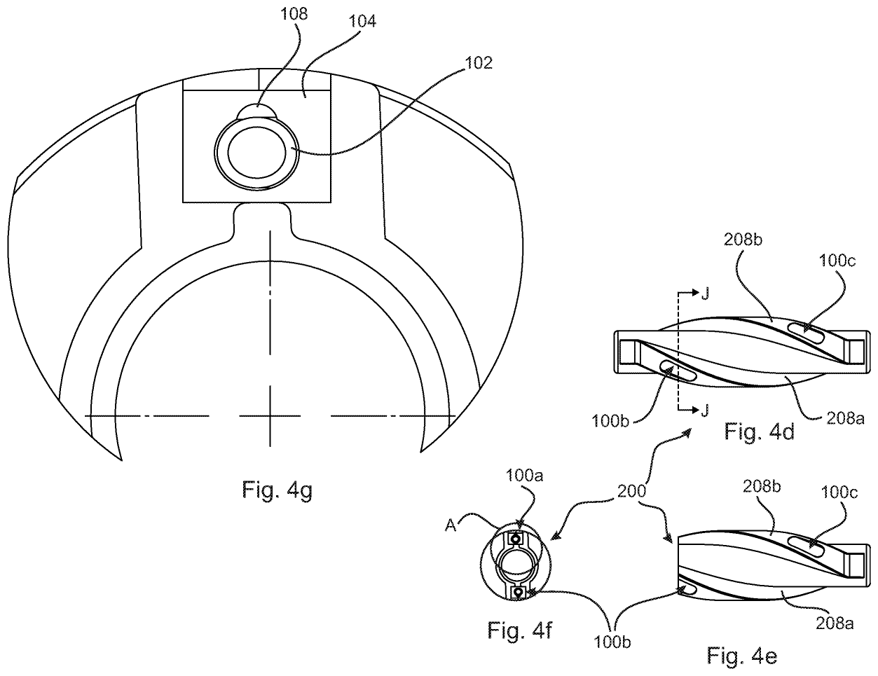

A well component according to a first embodiment of the fifth aspect of the present invention is depicted in FIGS. 4a to 4g. The well component, in the form of a sucker rod guide 200 comprises a body formed from wearable material and comprising a first body 202 which is adapted to be mounted on a sucker rod and a second body 204 which is adapted to be mounted on the first body 202. The first body 202 includes two ridges 206a, 206b that each define a spiral path along the length of the outer surface of the first body 202. When the second body 204 is mounted to the first body 202, vanes 208a, 208b on the second body 204 align with the ridges 206a, 206b on the first body to interlock the first body 202 and the second body 204.

The second body 204 includes four retaining means in the form of voids or cavities for four receptacles 100a, 100b, 100c and 100d corresponding to receptacle 100 from FIGS. 2 and 3a to 3d. Only two the cavities 250b, 250d are visible in the figures (see FIG. 4c). The cavities (including 250b, 250d) are located in fluid flow enhancers in the form of vanes 208a, 208b and, more particularly, in the first part of the vanes 208a, 208b that define a spiral shaped path around and along the length of the outer surface of the second body 204. The receptacles 100a-d are friction fitted and affixed in the cavities (including 250b, 250d) using a suitable adhesive.

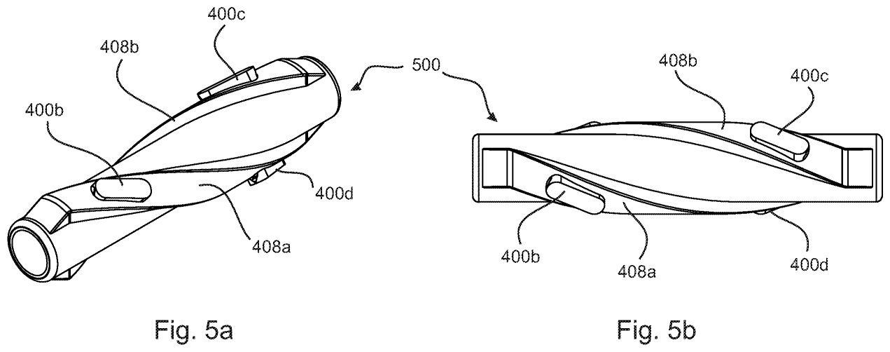

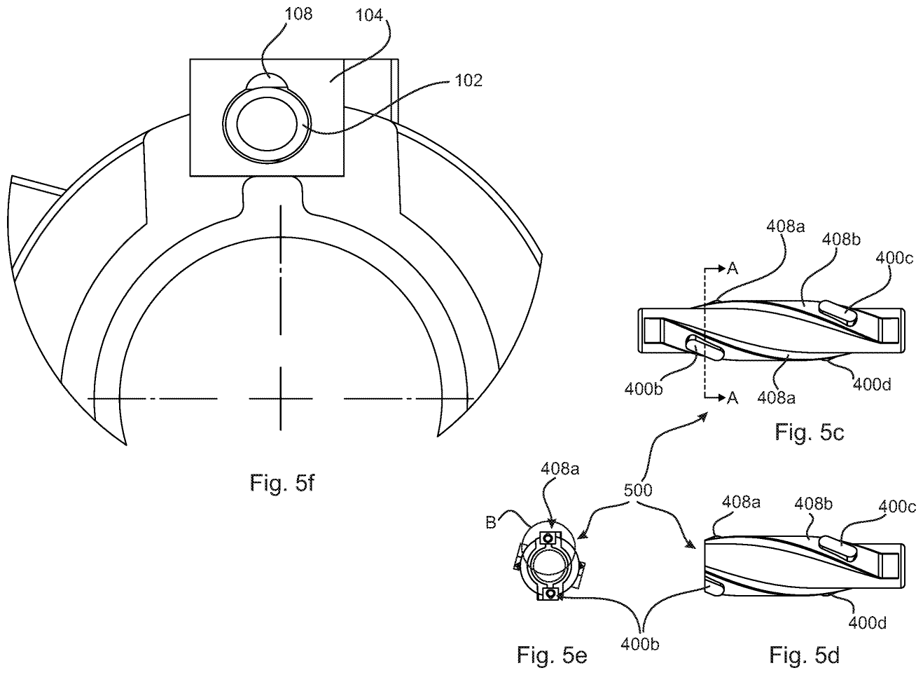

A well component according to a second embodiment of the fifth aspect of the present invention is depicted in FIGS. 5a to 5f. The second embodiment is also a sucker rod guide 500 and is similar to the sucker rod guide 200 of the first embodiment and the same reference numerals have been used to refer to features that are identical in the two embodiments. The main difference between the sucker rod guides 200, 500 is that the sucker rod guide 500 has lower profile vanes 408a, 408b. This results in the four receptacles 400a, 400b, 400c and 400d being mounted in the vanes 408a, 408b and extending beyond the outer surface of the vanes 408a, 408b.

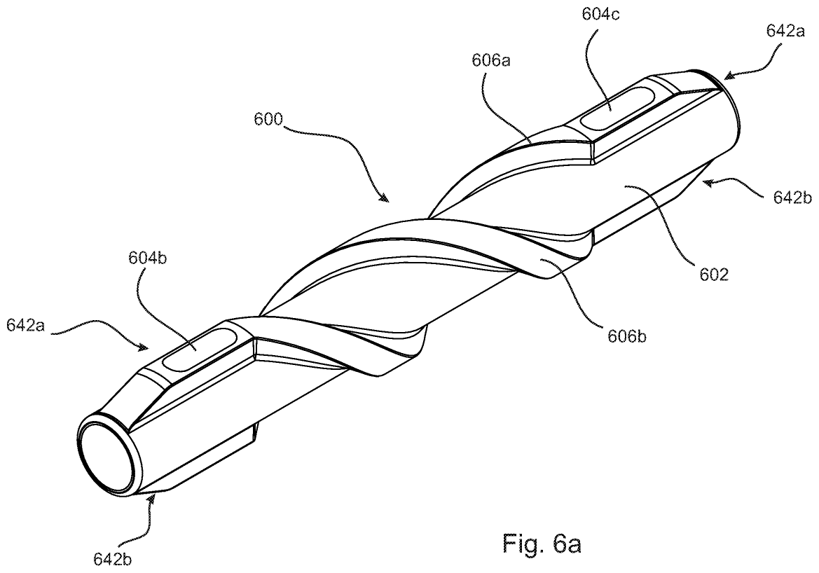

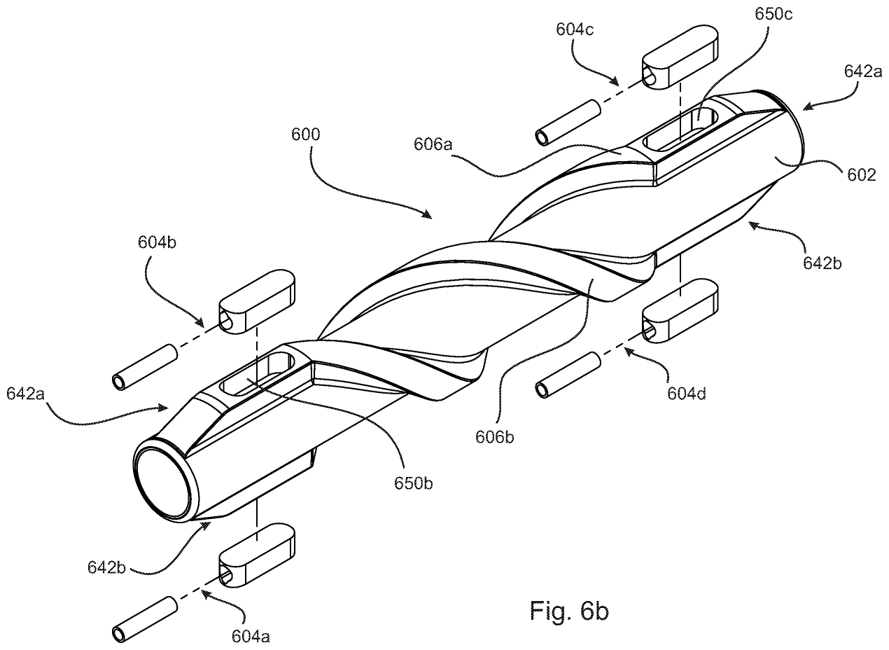

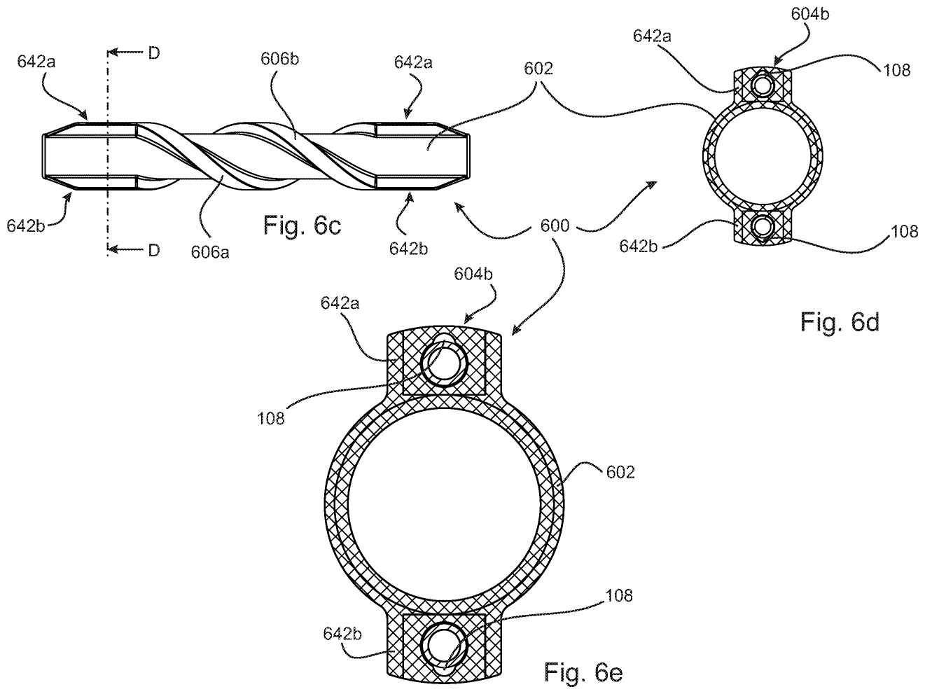

A well component according to a third embodiment of the fifth aspect of the present invention is depicted in FIGS. 6a to 6e. The well component, in the form of a sucker rod guide 600 comprises a body 602 formed from wearable material and which is adapted to be mounted on a sucker rod. The body 602 includes two ridges 606a, 606b that each define a spiral path along the length of the outer surface of the first body 602.

The body 602 includes four retaining means in the form of voids or cavities for four receptacles 604a, 604b, 604c and 604d that correspond to receptacle 100 from FIGS. 2 and 3a to 3d. Only two the cavities 650b, 650c are visible in the figures (see FIG. 6b). The cavities (including 650b, 650c) are located in fluid flow enhancers in the form of vanes 606a, 606b. In this embodiment, vanes 606a, 606b include a first part 640a, 640b that define a spiral shaped path around and along the length of the outer surface of the body 602 and a second part 642a, 642b at each end of the first part that defines a straight path along the outer longitudinal surface of the body 602 of the sucker rod guide. The receptacles 604a-d are located in the second parts 642a, 642b and affixed in the cavities (including 650b, 650c) via a friction fit and adhesive.

The claims appended hereto are meant to cover all modifications and changes within the scope and spirit of the present invention.

1-58. (canceled)

59. A rod guide for use in a well production tubing, the rod guide comprising:
(a) a wearable material; and
(b) a fluorophore located in a retaining means in the wearable material.

60. The rod guide according to claim 59 wherein the fluorophore comprises an excitation wavelength of 325-425 nm.

61. The rod guide according to claim 59 wherein the fluorophore is 1,3,6,8-pyrene tetrasulfonic acid tetrasodium salt (PTSA).

62. The rod guide according to claim 59 wherein the retaining means is adapted to release the fluorophore when a part of said retaining means is breached.

63. The rod guide according to claim 59 wherein the retaining means comprises a receptacle that defines a cavity or void in the wearable material.

64. The rod guide according to claim 63 wherein the receptacle is formed from a material that is less wear resistant than the wearable material.

65. The rod guide according to claim 59 comprising a plurality of retaining means.

66. The rod guide according to claim 63 wherein the receptacle comprises:
(a) a frangible capsule including a detectable material; and
(b) a housing for the frangible capsule, wherein the housing comprises a second wearable material.

67. The rod guide according to claim 66 wherein the frangible capsule is formed from glass.

68. The rod guide according to claim 66 wherein the frangible capsule is formed from ceramic or acrylic material.

69. The rod guide according to claim 66 wherein the frangible capsule comprises at least one end comprising a seal.

70. The rod guide according to claim 66 wherein the detectable material is a fluorescent material selected from the list consisting of fluorescein, rhodamine, lissamine, coumarin, perylene and chlorophyllin.

71. The rod guide according to claim 66 wherein the housing comprises a chamber that is shaped and sized to receive the frangible capsule.

72. The rod guide according to claim 71 wherein the chamber comprises a first part for receiving the frangible capsule and a second part that defines an expansion space or void for expediting the release of the detectable material when the frangible capsule is breached.

73. The rod guide according to claim 72 wherein the expansion space or void extends parallel to a main longitudinal axis of the first part of the chamber and towards an outer surface of the housing.

74. The rod guide according to claim 59 wherein the retaining means is located in a fluid flow enhancer that forms part of the rod guide.

75. The rod guide according to claim 74 wherein the fluid flow enhancer is a vane.

76. The rod guide according to claim 75 wherein the retaining means is located in a first part of the vane that defines spiral shaped path around and along an outer longitudinal surface of the body of the fluid flow enhancer.

77. The rod guide according to claim 76 wherein the retaining means is located in a second part of the vane that defines a straight path along the outer longitudinal surface of the body of the fluid flow enhancer.

78. An assembly for use in a well production tubing, the assembly comprising a plurality of rod guides according to claim 59.
